(19) United States
(12) Patent Application Publication
(10) Pub. No.: US 2007/0033614 A1
(43) Pub. Date: Feb. 8, 2007

(54) Method for creating unique customized television schedules

(76) Inventor: Roy W. Huffman JR., Decatur, GA (US)

Correspondence Address: Drake Jeffries, PO Box 250227, Atlanta, GA, 30325, US

(21) Appl. No.: 11/197,169

(22) Filed: Aug. 4, 2005

(51) Int. Cl. H04N 5/445; G06F 3/00; G06F 13/00; H04N 7/16

(52) U.S. Cl. 725/45; 725/46; 725/1

(57) ABSTRACT

A method for creating unique customized television schedules and renting viewing rights to those schedules to customers includes the computer-implemented steps of receiving an offering from a producer, the offering being a description of an unproduced episodic show; displaying a list of these offerings to customers through a website; receiving a slate of shows that the customer wishes to view; producing the offerings that meet a minimum number of subscribers; placing the shows on a storage medium in accordance with a customer's slate; and presenting the storage medium to the customer on a periodic basis.

### FIELD OF THE INVENTION

The present invention relates to a method for delivering original, unpublished, episodic media content (i.e. television shows). It is particularly concerned with a computer-implemented method that allows consumers to create, from a list of proposed but not yet produced shows, a slate of television programs to view.

### BACKGROUND OF THE INVENTION

The current system for supplying periodic media content to consumers is inadequate to meet all consumers' demands. Some of the reasons for this include limited bandwidth, the need for funding, the need to maximize revenue for each bandwidth segment, the limited contact between producers and viewers, and the fact that consumers have very little direct influence over what is produced.

The amount of media content that can be shown on television is limited by the amount of current bandwidth available. Consequently episodic media distributors must choose programming that will attract the largest number of those viewers that are sought for a specific time slot. These preferences are often based on such inadequate systems as the Nielsen ratings or advertiser preferences instead of being directly based upon viewer preferences.

For example, while 30% of viewers may enjoy watching Show A, 25% Show B, 25% Show C, and 20% Show D, the broadcaster is going to air Show A because it will generate the most viewers. Alternatively, the broadcaster may air Show D if advertisers are willing to pay more for that specific audience. The result of such a system is that 100% of consumers are forced to watch what only 30% or even 20% of consumers prefer in our example. Numerous niche segments that prefer to create and view alternative periodic media content are thus marginalized.

In addition, for every television project that is approved, several similar projects that might be equally appreciated by consumers must be rejected as there is only one time slot or distribution channel available. While five shows may elicit very similar levels of popularity amongst viewers, only one of those shows can be aired. The result is missed opportunities for producers and the loss of content for viewers.

Episodic media content can be very expensive to produce. In order to meet the financial burden these projects entail, producers typically turn to funding derived from advertising. As the scope and cost of a particular project goes up, more advertisements must be inserted into each episode. Many viewers find the advertising to be excessive and aggravating. In addition, advertising might only be targeted at one segment of the audience. This is a waste for advertisers and an annoyance for viewers.

Another way that producers obtain the money needed to produce a show is to search out investors. Often the number of investors is quite small and thus the content of the show is dictated by just a few homogeneous viewpoints. Viewers across America rarely have the same feelings about any issue. By placing the decision about what to produce in the hands of just a few people, numerous viewer preferences are ignored. Thus the current system of studio funded, produced, and distributed content leads to limited plots, characters, etc. and is inadequate to meet the diverse demand exhibited by those outside the studio's walls.

Viewers have very few options for making their demand known to producers. One option is to buy products advertised on their favorite show and hope that effort will be translated back as support for the show. Another option, as mentioned above, is to use such systems as the Nielsen ratings. The problem with those systems is that they do not account for the niche markets that could afford to fund numerous projects by themselves if they had a means of consolidating their demand. That is the goal of the current invention.

Previous computer-implemented systems have used websites to sell or rent media content to consumers. These systems bypass the limited bandwidth problem inherent in traditional television and cable networks. They also give customers the ability to “time-shift.” People no longer have to watch the content at a time predetermined by a network system.

The problem with these sites is that consumers only get to choose from a selection of previously released content. Consumers can choose which item to watch and when to watch it but the consumer has very little influence over the content creation and certainly no way to customize the content to his/her liking. Consumers cannot choose to receive new and timely content as it is produced. Furthermore, they are unable to define a custom set of programming to receive on a regular basis.

U.S. Pat. No. 6,584,450 discloses a computer-implemented approach for renting items to customers where customers select items and have them delivered. Unlike the present invention, consumers have to choose from a predetermined content selection made up of previously released items. In addition, U.S. Pat. No. 6,584,450 incorporates a rental system which means that consumers have to return a certain number of items before they can receive any more items.

U.S. Pat. No. 6,020,883 discloses a system and method for scheduling broadcast of and access to video programs and other data using customer profiles. The system uses an “agreement matrix” to find correlations between customer profiles and content profiles after which the highly correlated content is distributed to the customer through a network such as a cable television system.

U.S. Pat. No. 6,020,883 continues to pigeonhole customers into a small range of content based on a customer profile that may or may not reflect the true desires of the customer. In addition, the profiles associated with the content are subjectively decided by someone other than the customer and may not reflect the customer's own feelings about the description of the content.

U.S. Patent Application 2004/0225575 discloses a system for selectively storing recorded material onto a storage medium. Customers choose from a selection of prerecorded materials and build a play list of content. The content thus chosen is recorded on a storage medium such as a CD and distributed to the customer.

current invention provides a means for viewers to directly select and fund the production of episodic media content. The current invention provides a direct link between consumer demand and the talents of numerous individual producers, thus addressing the needs of smaller producers in reaching their prospective audiences, allowing for much greater variation in content offerings, and providing control of bothersome issues such as advertising.

### BRIEF SUMMARY OF THE INVENTION

The present invention relates to a process whereby individual customers select and build slates of episodic media content that has not been produced or has not been made publicly available. The listing of potential episodic media content is generated by individual producers. When a producer-defined threshold of demand for the potential episodic media content is reached, the producer produces the content and makes it available to the customer on a periodic basis.

The key to the present invention is the consolidation of demand generated by the consumers. Instead of accepting whatever episodic media content a distributor believes will be popular, the invention allows individual consumers to choose what episodic media content will be produced. By consolidating consumer demand and resources, consumers can dictate the episodic media content at the beginning of the production process rather than waiting to choose from what producers have already produced. Producers can also be assured of an enthusiastic market before beginning production.

In one embodiment of the invention, consumers visit a website where they are presented with numerous episodic media content offerings by individual producers. As the consumers peruse the offerings, they choose and add offerings they would like to see to a personal slate.

Consumer choices are tabulated and tracked for each proposed show. When enough consumers have chosen an individual offering, a producer-defined threshold level is reached. Upon attaining the producer-defined threshold of consumers interested in the offering, the responsible producer is signaled that production of the offering is financially feasible.

The producer should then go ahead with production. As episodic media content offerings are produced, the content is placed on a storage medium such as a DVD and sent periodically to the consumer. The storage medium could also be a VCR cassette, Video CD, Non-volatile RAM (flash, SDRAM, etc.), EPROM, or FLASH-EPROM, electronically delivered data packet, or any suitable device for storing the media content. The consumer may be billed for the content at the time the content is sent to the consumer and the producers of the content may be paid at that time.

The present invention allows consumers the ability to customize their content selection instead of merely choosing from what is already on the market. By allowing consumers to customize the media content from the very beginning of production, numerous advantages are afforded the consumer that are not available under the system disclosed in U.S. Pat. No. 6,584,450. By allowing producers to directly reach potential viewers also allows those producers to tailor their content to very small niches.

Consumers can opt to not have any advertising placed in the media content or they can request advertising in order to reduce the cost of their content. Consumers do not have to return items before receiving more items and finally, there is no upper limit as to the number of items a consumer can have delivered at any one time under the present invention.

Unlike U.S. Pat. No. 6,020,883, the present invention does not use customer profiles. Customers specifically select the episodic media content they wish to watch. The present invention takes into account that customers' viewing preferences may cover a number of genres and can change rapidly.

Unlike U.S. Patent Application 2004/0225575, the present invention does not simply offer prerecorded material for the customer to choose from. The present invention offers customers a listing of potential media content that will not be produced until a certain level of demand is met. Customers do not add recorded items to their slates. Instead, they express a desire to see the offered media content which, when aggregated, brings into being an overall demand for the content. If the overall level of demand is high enough to make the production of the as yet unproduced media content feasible, the item is then produced and sent to the customer who initially selected it.

### BRIEF DESCRIPTION OF THE SEVERAL VIEWS OF THE DRAWING(S)

FIG. 1 is a block diagram of the systems of the present invention;

FIG. 2 is a flow diagram of a method of the present invention from the customer's perspective;

FIG. 3 is a flow diagram of a method of the present invention from the producer's perspective; and

FIG. 4 is a flow diagram of a method of the present invention at the periodic distribution time.

### DETAILED DESCRIPTION OF THE INVENTION

The present invention generally relates to a method for consolidating customer demand for particular episodic media content. Customer resources are aggregated and allocated to particular episodic media content that has not yet been produced. When a producer-defined threshold of customer demand is reached, individual producers are signaled to produce the episodic media content for the customers. The shows produced by the producers are then aggregated on a storage medium and presented to the customer according to the slate of selections built by the customer.

The following description will describe the process (1) as an overall system; (2) from the customer's perspective; (3) from the producer's perspective; and (4) at the periodic time when the customer's slate of selections is aggregated on a storage medium and presented to the customer.

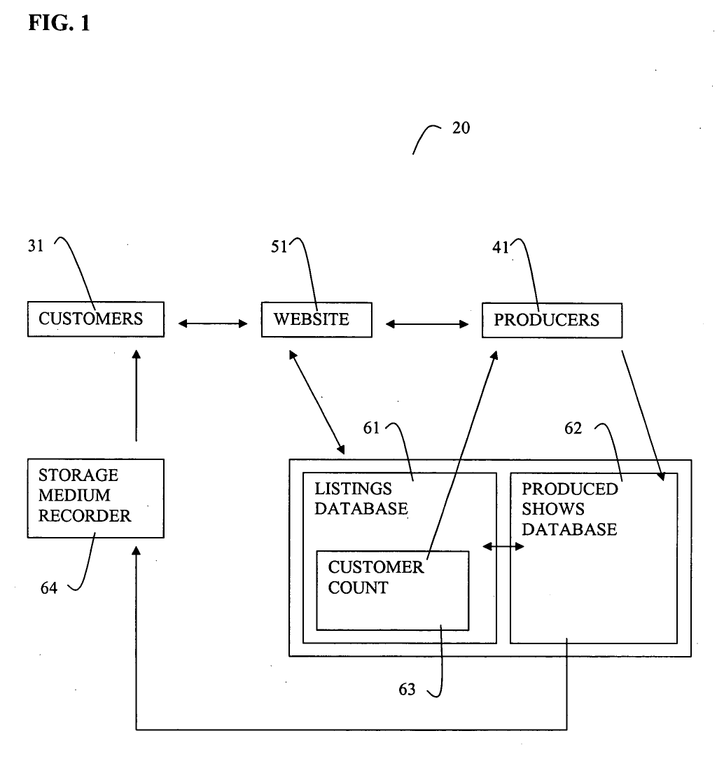

Referring now to FIG. 1, the system 20 includes customers 31 that visit a website 51. Producers 41 also access the system 20 via a website 51. Producers 41 submit offerings of potential episodic media content not presently in existence to the website 51. The offerings may be textual descriptions of the offering, trailers of the offering or any other device that serves to describe the offering. The producer's submissions are stored in a listings database 61.

Customers 31 are able to preview the listings in the listings database 61 through the website 51. Customers 31 may select listings that they wish to see in the future and place them on a slate 36. The listings database 61 keeps a “customer count” 63 of the number of customers selecting a particular offering. When a certain producer-defined threshold number of customers have selected a particular offering, the producer of the offering is signaled to begin production of the offering. The resulting productions are stored in a produced shows database 62.

At predetermined periodic times, a customer's slate of selections is checked against the produced shows database 62. Customer selections that have been produced are then sent to a storage medium recorder 64 that records the productions onto a storage medium such as a CD, DVD or any suitable device. The storage medium is then presented to the customers 31 and the customers are billed for the productions. The producers 41 may also be paid at this time.

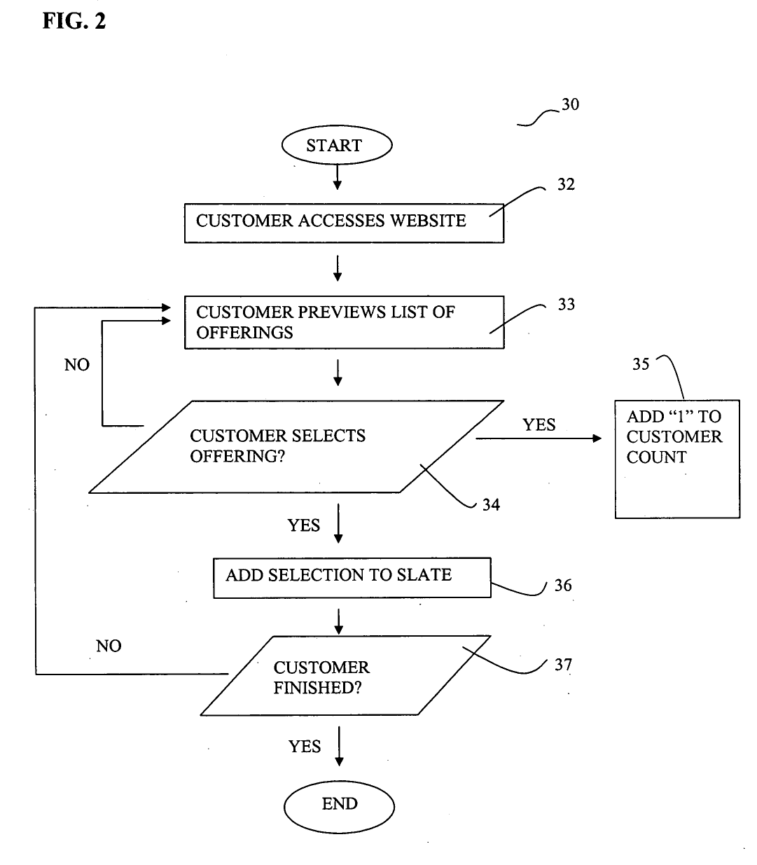

FIG. 2 is a flow diagram of a method of the present invention from the customer's perspective. Customers 31 start at step 32 by accessing the website 51. At step 33, customers view the list of offerings submitted by producers 41.

At step 34 a customer is given the choice to select a particular offering. If the customer does select a particular offering, the offering is added to the customer's slate of selections (step 36). If the customer does not wish to select a particular offering, the customer returns to step 33 to preview more offerings.

If the customer does select an offering at step 34, the selection is added to the customer's slate (step 36) and the customer count 63 of customers selecting that particular offering is increased by one (step 35).

A “customer count” is maintained by the system 20. When the number of customers selecting a particular offering reaches a producer-defined threshold (when the customer count 63 reaches a minimum threshold (step 43)) a signal is sent to the producer area of the system 40.

After a customer selection is added to the customer's slate at step 36, the customer may be given the option of continuing to preview the listings database 61 (step 37). If the customer wishes to continue previewing the listings database 61, the customer returns to step 33. If the customer wishes to discontinue previewing the listings database 61, the customer may exit the system 30.

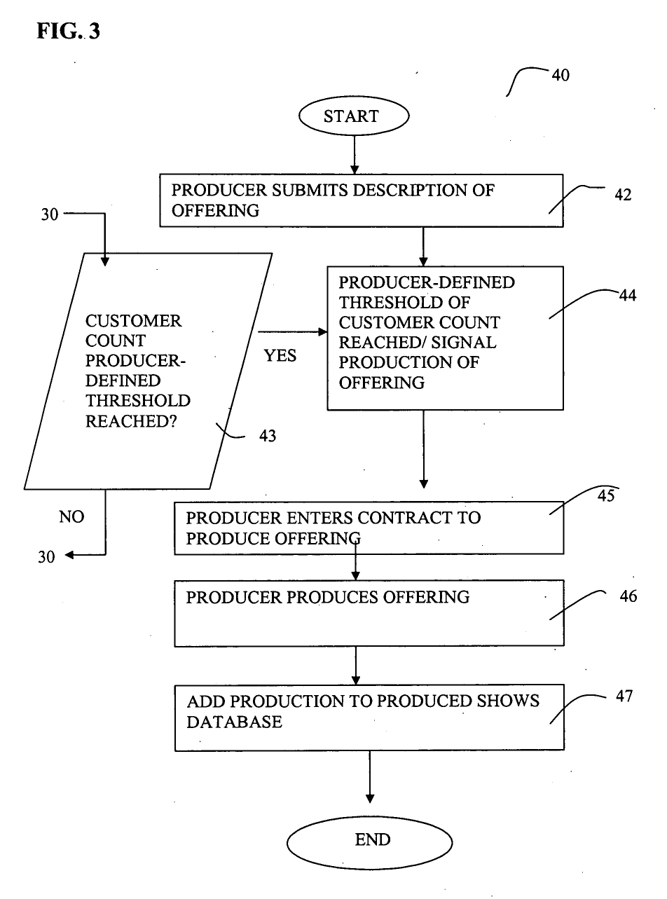

FIG. 3 is a flow diagram of a method of the present invention from the producer's perspective. The system 40 begins when the producers 41 submit a number of descriptions of the episodic media content they wish to offer to the customers 31 (step 42). If the customer count 63 for any particular offering reaches a producer-defined threshold as in step 43, the producer who initially submitted the offering is signaled that production of the offering should begin (step 44).

The producer may enter into a contract to produce the offering as in step 45. The producer then proceeds with production of the offering as in step 46. Once the offering is produced (step 46), the newly produced episodic media content is placed on the produced shows database 62 (step 47).

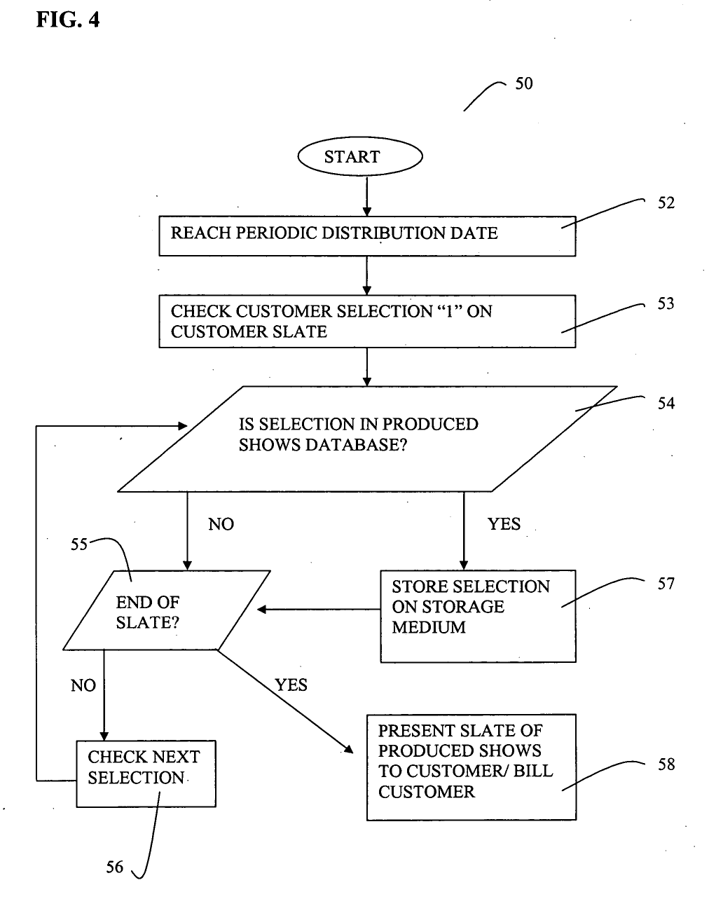

FIG. 4 is a flow diagram of a method of the present invention at the periodic distribution time. The system 50 goes into effect at a periodic distribution date (step 52). The system 50 may check the first selection on a customer's slate as in step 53. The system 50 queries the produced shows database 62 to see whether the selection has been produced (step 54).

If the selection has not been produced, the system 50 asks whether the end of the customer's slate has been reached (step 55). If not, the system 50 will proceed to the next selection on the slate as in step 56. The system 50 will then return to step 54 to see if the new selection is in the produced shows database 62.

Returning now to step 54, if the customer's selection on the slate is found in the produced shows database 62, the system 50 will move to step 57 whence the produced show coinciding with the selection is stored on a storage medium by the storage medium recorder 64. The system 50 then proceeds back to step 55 to determine whether all the selections on the slate have been processed in accordance to the foregoing.

If the system 50 determines at step 55 that the end of the slate has been reached and there are no further selections to process, the system 50 proceeds to step 55 the storage medium containing the produced shows coinciding with the customer's selection slate is presented to the customer. The customer is billed at the time the slate of programs is presented (step 58).

While the invention has been described in conjunction with specific embodiments, it is evident that many alternatives, modifications and variations will be apparent to those skilled in the art in light of the foregoing description. Accordingly, the present invention attempts to embrace all such alternatives, modifications and variations that fall within the spirit and scope of the appended claims.

What is claimed is:

1. A method for creating unique customized television schedules, the method comprising the computer-implemented steps of:
a. Displaying to a customer a list of descriptions of offerings, wherein said offerings are unproduced, episodic media content;
b. Receiving from said customer a slate of selections from the list of descriptions of offerings;
c. In response to meeting a producer-defined threshold number of customers selecting a particular description of an offering, producing said offering.

2. The method of claim 1 further comprising the step of receiving said descriptions of offerings from individual producers.

3. The method of claim 1 further comprising the step of placing the newly produced offerings onto a storage medium in accordance with a customer's slate.

4. The method of claim 3 further comprising the step of presenting the storage medium to the customer.

5. The method of claim 4, wherein the storage medium is presented to the customer on a periodic basis.

6. The method of claim 5 further comprising the step of billing the customer.

7. The method of claim 6 further comprising the step of paying the producer at the time the customer is billed.

8. The method of claim 1, wherein the unproduced media content comprises episodes.

9. A method for creating unique customized television schedules, the method comprising the computer-implemented steps of:
a. Receiving an offering from a producer, wherein said offering is a description of a presently unproduced, episodic media content;
b. Displaying to a customer a list of said offerings;
c. Receiving from said customer a slate, wherein said slate is a selection of said offerings that the customer wishes to view;
d. In response to meeting a minimum threshold of customers selecting a particular offering, producing said offering;
e. Placing the newly produced offerings onto a storage medium in accordance with a customer's slate; and
f. Presenting said storage medium to the customer on a periodic basis.

10. The method of claim 9, wherein the producers submit offerings to a website and a customer views the list of offerings via a website.

11. The method of claim 9 further comprising the step of entering into a contract with an individual producer to produce an offering.

12. The method of claim 9, wherein the storage medium is a DVD, VCR cassette, Video CD, non-volatile RAM, PROM, EPROM, or FLASH-EPROM.

13. The method of claim 9, wherein the viewing rights to the content on the storage medium are rented to the customer.

14. A system for creating unique customized television schedules, comprising:
a. A listing database for storing descriptions of offerings, wherein said descriptions are descriptions of unproduced, episodic media content submitted by producers;
b. A customer count device for counting the number of customers selecting a particular offering;
c. A produced shows database for storing produced, episodic media content;
d. A storage medium recorder having access to the produced shows database and configured to record produced shows onto a storage medium in accordance with a particular customer's selection of offerings; and
e. A website for receiving descriptions of offerings from producers and for displaying offerings to customers.
